(19) United States
(12) Patent Application Publication
(10) Pub. No.: US 2025/0130443 A1
(43) Pub. Date: Apr. 24, 2025

(54) ELECTRONIC PAPER DISPLAY PANEL AND DISPLAY DEVICE

(71) Applicant: Shanghai Tianma Microelectronics Co., Ltd., Shanghai (CN)

(72) Inventor: Jian JIN, Shanghai (CN)

(73) Assignee: Shanghai Tianma Microelectronics Co., Ltd., Shanghai (CN)

(21) Appl. No.: 18/592,707

(22) Filed: Mar. 1, 2024

(30) Foreign Application Priority Data
Oct. 23, 2023 (CN) 202311378424.7

(51) Int. Cl. G02F 1/00; G02F 1/1335; G02F 1/167

(52) U.S. Cl. CPC G02F 1/0081; G02F 1/167; G02F 1/133502

(57) ABSTRACT

Provided are an electronic paper display panel and a display device. The electronic paper display panel includes a first substrate and a second substrate opposite to each other and a plasma layer between the first substrate and the second substrate. The plasma layer includes an electrophoretic fluid and first-type charged particles. The first-type charged particles have charges with a first electrical property. The first-type charged particles include first charged subparticles and second charged subparticles. The particle size of a first charged subparticle is D₁. The particle size of a second charged subparticle is D₂. The charge quantity carried by the first charged subparticle is q₁. The charge quantity carried by the second charged subparticle is q₂. (D₁-D₂)×(q₁-q₂)>0.

### CROSS-REFERENCE TO RELATED APPLICATION(S)

This application claims priority to Chinese Patent Application No. 202311378424.7 filed with the China National Intellectual Property Administration (CNIPA) on Oct. 23, 2023, the disclosure of which is incorporated herein by reference in its entirety.

### TECHNICAL FIELD

Embodiments of the present disclosure relate to the field of display technology, particularly an electronic paper display panel and a display device.

### BACKGROUND

With the development of display technology, various display devices gradually enter the market. An electronic paper display device displays text or images by reflecting the ambient light. The experience of reading an electronic paper is similar to that of reading a paper print. Electronic papers are eye-protective, comfortable, and environment-friendly and thus have been increasingly widely used in recent years. The electronic paper display technology mainly uses the electrophoretic display technology to adjust the arrangement of electrophoretic particles in an electrophoretic fluid to achieve different light reflection effects to achieve frame display. However, in the related art, an electronic paper display device still has the defects of low contrast and poor display effect.

### SUMMARY

In view of this, the present disclosure provides an electronic paper display panel and a display device to improve the contrast and display effect of the electronic paper display panel.

An embodiment of the present disclosure provides an electronic paper display panel. The electronic paper display panel includes a first substrate and a second substrate opposite to each other and a plasma layer between the first substrate and the second substrate.

The plasma layer includes an electrophoretic fluid and first-type charged particles. The first-type charged particles have charges with a first electrical property. The first-type charged particles include first charged subparticles and second

charged subparticles. The particle size of a first charged subparticle is D₁. The particle size of a second charged subparticle is D₂. The charge quantity carried by the first charged subparticle is q₁. The charge quantity carried by the second charged subparticle is q₂.

(D₁-D₂)×(q₁-q₂)>0.

An embodiment of the present disclosure provides a display device. The display device includes an electronic paper display panel. The electronic paper display panel includes a first substrate and a second substrate opposite to each other and a plasma layer between the first substrate and the second substrate. The plasma layer includes an electrophoretic fluid and first-type charged particles. The first-type charged particles have charges with a first electrical property. The first-type charged particles include first charged subparticles and second charged subparticles. The particle size of a first charged subparticle is D₁. The particle size of a second charged subparticle is D₂. The charge quantity carried by the first charged subparticle is q₁. The charge quantity carried by the second charged subparticle is q₂. (D₁-D₂)× (q₁-q₂)>0.

### BRIEF DESCRIPTION OF DRAWINGS

FIG. 1 is a diagram illustrating the structure of an electronic paper display panel according to the related art.

FIG. 2 is an enlarged view of A of FIG. 1.

FIG. 3 is a diagram illustrating the structure of an electronic paper display panel according to an embodiment of the present disclosure.

FIG. 4 is an enlarged view of A of FIG. 3.

FIG. 5 is a diagram illustrating the structures of first-type charged particles according to an embodiment of the present disclosure.

FIG. 6 is a diagram illustrating variations in the electric intensity of a first electric field according to an embodiment of the present disclosure.

FIG. 7 is a diagram illustrating variations in the electric intensity of another electric field according to an embodiment of the present disclosure.

FIG. 8 is a drive timing diagram of an electronic paper display panel according to an embodiment of the present disclosure.

FIG. 9 is a diagram illustrating the structure of another electronic paper display panel according to an embodiment of the present disclosure.

FIG. 10 is a diagram illustrating light reflection of charged particles according to an embodiment of the present disclosure.

FIG. 11 is a diagram illustrating the structures of second-type charged particles according to an embodiment of the present disclosure.

FIG. 12 is a diagram illustrating the structure of another electronic paper display panel according to an embodiment of the present disclosure.

FIG. 13 is a diagram illustrating variations in the electric intensity of a second electric field according to an embodiment of the present disclosure.

FIG. 14 is a diagram illustrating variations in the electric intensity of another second electric field according to an embodiment of the present disclosure.

FIG. 15 is a diagram illustrating the structure of another electronic paper display panel according to an embodiment of the present disclosure.

FIG. 16 is a diagram illustrating the structure of another electronic paper display panel according to an embodiment of the present disclosure.

FIG. 17 is a diagram illustrating the structure of a display device according to an embodiment of the present disclosure.

### DETAILED DESCRIPTION

The present disclosure is described in detail hereinafter in conjunction with drawings and embodiments. It is to be understood that the embodiments described herein are intended to illustrate the present disclosure and not to limit the present disclosure. Additionally, it is to be noted that for ease of description, only part, not all, of structures related to the present disclosure are illustrated in the drawings.

The terms used herein are intended to describe embodiments and not to limit the present disclosure. Terms such as “include” and “contain” used herein indicate the presence of described features, steps, operations, and/or components but do not exclude the presence or addition of one or more other features, steps, operations, or components.

It is to be understood that the orientation or positional relationship indicated by a term such as “longitudinal”, “length”, “circumferential”, “front”, “rear”, “left”, “right”, “top”, or “bottom” in the description of the present disclosure is based on a drawing. The term is used for ease and simplicity of description of the present disclosure and not for indicating or implying that a subsystem or element described must have a certain orientation or must be constructed or operated in a certain orientation and thus is not to be construed as limiting the present disclosure.

The same elements throughout the drawings are denoted by the same or similar reference numerals. When likely to cause a confused understanding of the present disclosure, a conventional structure or construction is omitted. The shape, size, or positional relationship of each component in a drawing does not reflect the actual size, proportion, or positional relationship. Any reference sign in a bracket of a claim does not limit the claim.

Similarly, to simplify the present disclosure and help understand one or more of the aspects of the present disclosure, features of the present disclosure in the description of example embodiments of the present disclosure are sometimes grouped into a single embodiment, drawing, or description thereof. The description of a reference term such as “an embodiment”, “some embodiments”, “example”, or “some examples” means that features, structures, materials, or characteristics described in conjunction with any preceding embodiment or example are included in at least one embodiment or example of the present disclosure. In the description, the illustrative description of any preceding term does not necessarily refer to the same embodiment or example. Moreover, the features, structures, materials, or characteristics described may be combined properly in one or more embodiments or examples.

Moreover, the terms “first” and “second” are for description purposes and are not to be construed as indicating or implying relative importance or implicitly indicating the number of technical features indicated. Thus, a feature defined as a “first” feature or a “second” feature may explicitly or implicitly include one or more such features. In the description of the present disclosure, unless otherwise specified, “multiple” means at least two, for example, two or three.

In the context of the present disclosure, a layer/element referred to as being “on” another layer/element is in contact with the other layer/element or is in contact with an intervening layer/element between the two layers/elements. Additionally, a layer/element on another layer/element in one direction is under the other layer/element in an opposite direction.

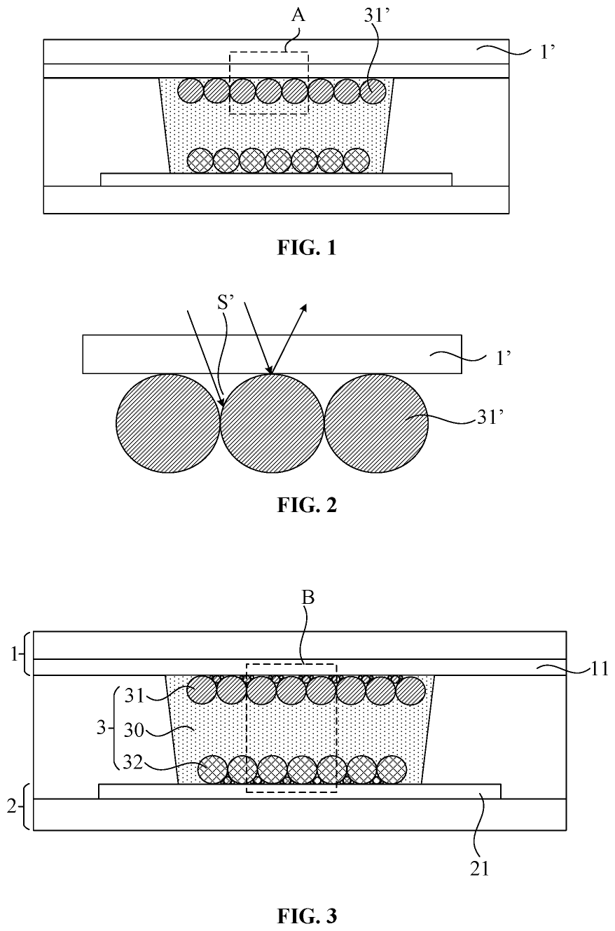

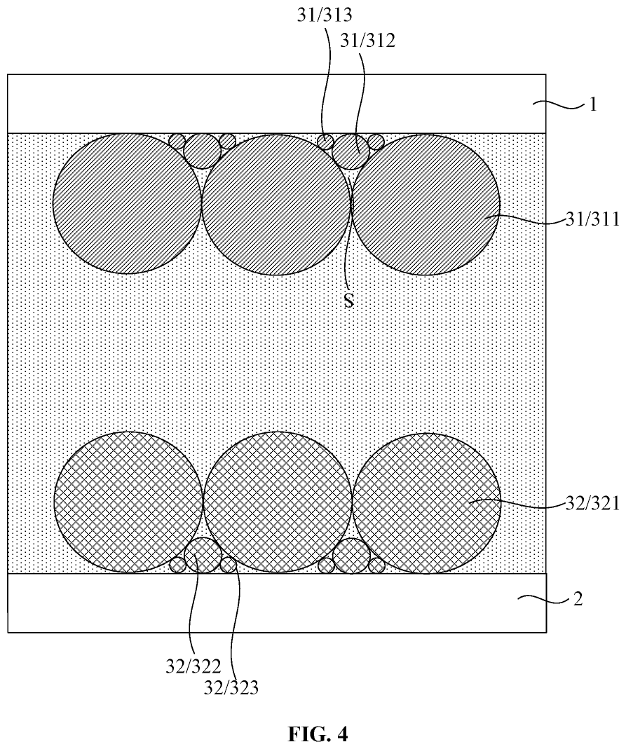

An electronic paper display panel generally includes an upper substrate, a lower substrate, and charged particles between the upper substrate and the lower substrate. When a voltage is applied to the upper substrate and the lower substrate, an electric field is formed between the upper substrate and the lower substrate, and the charged particles move under the action of the electric field. FIG. 1 is a diagram illustrating the structure of an electronic paper display panel according to the related art. FIG. 2 is an enlarged view of A of FIG. 1. Referring to FIGS. 1 and 2, charged particles of the same color in the related art have the same particle size. When the display panel displaying white is used as an example, a voltage is applied to control white charged particles 31′ to move to the upper substrate 1′, and the ambient light (indicated by arrows in the drawing) penetrates the upper substrate 1′ and illuminates the white charged particles 31′. The ambient light should have been effectively reflected from the surface of the white charged particles 31′ facing the upper substrate 1′. However, it is found by the inventors that since the white charged particles 31′ have the same particle size, the space S′ between two charged particles 31′ is large. Thus, the ambient light illuminating the space S′ cannot be effectively reflected from the white charged particles 31′, and the reflectivity of the white charged particles 31′ is not high. As a result, the white state of the display is not white, and the display effect of the electronic paper display panel is affected.

Based on the preceding defects of the related art, the present disclosure provides an electronic paper display panel. The electronic paper display panel includes a first substrate and a second substrate opposite to each other and a plasma layer between the first substrate and the second substrate.

The plasma layer includes an electrophoretic fluid and first-type charged particles. The first-type charged particles have charges with a first electrical property.

The first-type charged particles include first charged subparticles and second charged subparticles. The particle size of a first charged subparticle is D₁. The particle size of a second charged subparticle is D₂. The charge quantity carried by the first charged subparticle is q₁. The charge quantity carried by the second charged subparticle is q₂.

$$( {D}_{1} - {D}_{2} ) \times ( {q}_{1} - {q}_{2} ) > 0 .$$

This scheme enables a first-type charged particle having a smaller particle size to be packed into a space between two adjacent first-type charged particles having a larger particle size to achieve a dense arrangement of the first-type charged particles, thereby improving the ability of the first-type charged particles to reflect or absorb the ambient light, increasing the display contrast, and increasing the display effect. Additionally, the arrangement in which the charge quantity carried by a first-type charged particle having a larger particle size is greater than the charge quantity carried by a first-type charged particle having a smaller particle size can balance a moving-speed difference caused by a particle size difference, thereby ensuring that a first-type charged particle having a larger particle size has a sufficient drive force to move to the first substrate and thus ensures a dense arrangement of the first-type charged particles.

The preceding is the core idea of the present disclosure. The technical schemes of embodiments of the present disclosure are described clearly and completely hereinafter in conjunction with drawings in embodiments of the present disclosure.

Based on embodiments of the present disclosure, all other embodiments obtained by those of ordinary skill in the art without any creative effort are within the scope of the present disclosure.

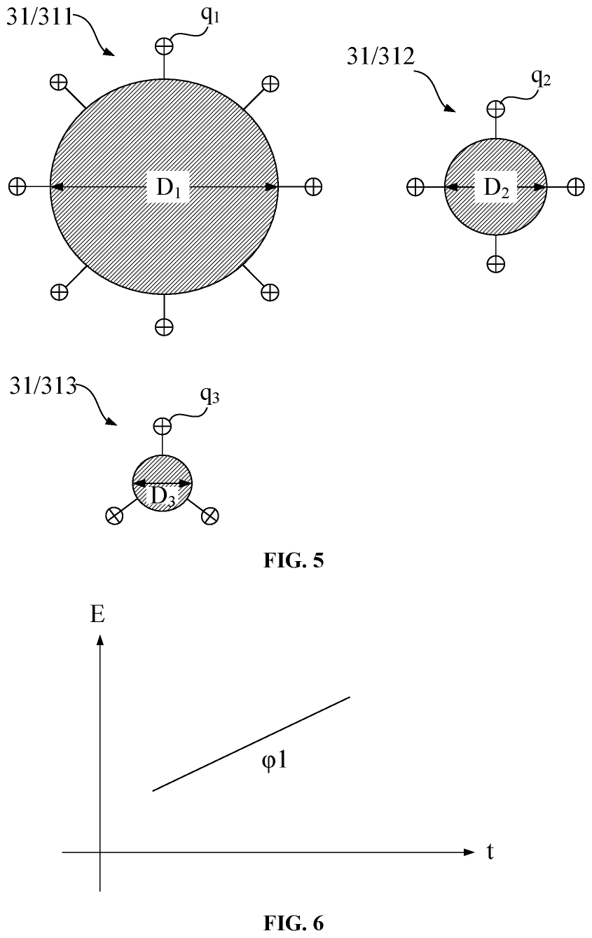

FIG. 3 is a diagram illustrating the structure of an electronic paper display panel according to an embodiment of the present disclosure. FIG. 4 is an enlarged view of A of FIG. 3. Referring to FIGS. 3 and 4, the electronic paper display panel includes a first substrate 1 and a second substrate 2 opposite to each other and a plasma layer 3 between the first substrate 1 and the second substrate 2. The plasma layer 3 includes an electrophoretic fluid 30 and first-type charged particles 31. Each first-type charged particle 31 has a charge with a first electrical property. The first-type charged particles 31 include first charged subparticles 311 and second charged subparticles 312. The particle size of a first charged subparticle 311 is D₁. The particle size of a second charged subparticle 312 is D₂. The charge quantity carried by the first charged subparticle is q₁. The charge quantity carried by the second charged subparticle is q₂.

$$( {D}_{1} - {D}_{2} ) \times ( {q}_{1} - {q}_{2} ) > 0 .$$

As shown in FIGS. 3 and 4, the second substrate 2 may be used as a carrier to carry other films of the electronic paper display panel. The second substrate 2 may be a glass substrate, that is, a rigid structure or may be a flexible substrate, that is, a flexible structure, to satisfy bending and other requirements. This is not limited by embodiments of the present disclosure. The first substrate 1 is stacked on one side of the second substrate 2. The electronic paper display panel has a display surface. The display surface may be a surface of the first substrate 1 facing away from the second substrate 2. When the electronic paper display panel is used, it is possible to make a certain image displayed on the display surface, and a user can see the image displayed on the display surface.

With continued reference to FIGS. 3 and 4, the plasma layer 3 is sandwiched between the first substrate 1 and the second substrate 2, and the plasma layer 3 includes an electrophoretic fluid 30 and charged particles. The charged particles are the main components in the electronic paper display panel to implement the display effect. The charged particles include first-type charged particles 31. The first-type charged particles 31 have the same electrical property. The first-type charged particles 31 may be, but are not limited to, white charged particles. The first-type charged particles 31 are white charged particles in the description herein.

The shape of the first-type charged particle 31 may be, but not limited to, a circle, a square, a polygon, or another irregular shape. In embodiments of the present disclosure, the shape of the first-type charged particle 31 is a circle.

It is to be noted that in embodiments of the present disclosure, the particle size and carried charge quantity of the first-type charged particle 31 may be set differentially. FIG. 5 is a diagram illustrating the structures of first-type charged particles according to an embodiment of the present disclosure. Referring to FIGS. 3 to 5, those skilled in the art can learn that a charged particle is generally a nanoparticle in a shape close to a sphere and the particle size is used to indicate the size in the radial direction of the charged particle, that is, the particle size of a charged particle in the shape of a sphere may be the diameter of the charged particle. The charge quantity carried by a charged particle may be the charge quantity carried on the surface of the charged particle. If a first-type charged particle 31 is positively charged, the charge quantity carried by the charged particle 31 is the charge quantity of the positive charge carried on the surface of the charged particle. If a first-type charged particle 31 is negatively charged, the charge quantity carried by the charged particle 31 is the charge quantity of the negative charge carried on the surface of the charged particle.

As shown in FIGS. 3 to 5, in embodiments of the present disclosure, the first-type charged particles 31 include first charged subparticles 311 and second charged subparticles 312. The first charged subparticles 311 and the second charged subparticles 312 refer to any two types of charged subparticles among the first-type charged particle 31, where each type of charged subparticles have a different particle size. The particle size and carried charge quantity of the first charged subparticles 311 are different from those of the second charged subparticles 312. The particle size of the first charged subparticle is D₁. The particle size of the second charged subparticle is D₂. The charge quantity carried by the first charged subparticle is q₁. The charge quantity carried by the second charged subparticle is q₂.

That the particle size and carried charge quantity of the first charged subparticle 311 are different from those of the second charged subparticle 312 enables a second charged subparticles 312 having a smaller particle size to be packed into a space between two adjacent first charged subparticles 311 having a larger particle size to achieve a dense arrangement of the first-type charged particles 31. When the first-type charged particles 31 are white charged particles and when the display panel displays white color, the first-type charged particles 31 need to be controlled to move to the surface of the first substrate 1 facing away from the display surface. Since the first-type charged particles 31 are arranged close to each other, partial ambient light may be reflected from the surface of a first-type charged particle 31 having a smaller particle size in the space S between two adjacent first charged subparticles 311 having a larger particle size after the partial ambient light illuminates the two adjacent first charged subparticles 311 having a larger particle size, thereby improving the efficiency in reflecting light in the plasma layer 3, making the white state whiter, and improving the display effect of the display panel.

For example, in FIGS. 4 and 5, the particle size D₁ of the first charged subparticle 311 is greater than the particle size D₂ of the second charged subparticle 312. With this arrangement, the second charged subparticle 312 can be packed into the space S between two adjacent first charged subparticles 311 to achieve a dense arrangement of the first-type charged particle 31. The particle size and carried charge quantity of each charged particle of this embodiment of the present disclosure are example values, not actual values.

Further, it should be understood that when the drive voltage is fixed, among charged particles having the same charge quantity, a larger resistance occurs between the electrophoretic fluid and a charged particle having a larger particle size, making the moving speed of a charged particle having a larger particle size less than the moving speed of a charged particle having a smaller particle size. When the drive voltage is fixed, among charged particles having the same size, a charged particle carrying a larger charge quantity is driven by a stronger force of the electric field, making the moving speed of a charged particle carrying a larger charge quantity higher than the moving speed of a charged particle carrying a smaller charge quantity.

In view of this, to reduce a moving-speed difference caused by a particle size difference between first-type charged particles 31 in this embodiment of the present disclosure, the charge quantity carried by a first-type charged particle 31 having a larger particle size is set greater than the charge quantity carried by a first-type charged particle 31 having a smaller particle size. For example, the particle size D₁ of the first charged subparticle 311 is greater than the particle size D₂ of the second charged subparticle 312, and the charge quantity carried by the first charged subparticle 311 is greater than the charge quantity carried by the second charged subparticle 312. In this manner, a moving-speed difference caused by a particle size difference of the first-type charged particles is reduced, a first-type charged particle 31 having a larger particle size is sufficiently driven to move to the first substrate 1, and the dense arrangement of the first-type charged particles 31 is ensured.

It is to be noted that this embodiment uses an example in which the first-type charged particles 31 include two types of charged particles (first charged subparticles 311 and second charged subparticles 312), where each type of charged particles have a different particle size and a different charge quantity. In other embodiments, the first-type charged particles 31 may include n types of charged particles (first charged subparticles 311, second charged subparticles 312, . . . , and n^{th}charged subparticles), where each type of charged particles have a different particle size and a different charge quantity. Among the n types of charged particles, any two types of charged particles satisfy the preceding relative relationship between the particle size and the charge quantity, that is, a first-type charged particle 31 having a larger particle size carries a larger charge quantity, and a first-type charged particle 31 having a smaller particle size carries a smaller charge quantity.

When a first-type charged particle 31 is prepared, it is feasible to adjust the particle size and carried charge quantity of the first-type charged particle 31 by adjusting various preparation conditions. For example, it is feasible to adjust the particle size of the first-type charged particle 31 by controlling the reaction time of the particle that is being prepared and adjust the carried charge quantity of the first-type charged particle 31 by controlling the number of active sites on the surface of the first-type charged particle 31. This may be set by those skilled in the art according to actual requirements and is not described and limited by embodiments of the present disclosure.

In this embodiment of the present disclosure, the electronic paper display panel includes a first substrate and a second substrate opposite to each other and a plasma layer between the first substrate and the second substrate. The plasma layer includes an electrophoretic fluid and first-type charged particles. The first-type charged particles have charges with a first electrical property. The first-type charged particles include first charged subparticles and second charged subparticles. The particle size of a first charged subparticle is D₁. The particle size of a second charged subparticle is D₂. The charge quantity carried by the first charged subparticle is q₁. The charge quantity carried by the second charged subparticle is q₂. (D₁-D₂)× (q₁-92)>0. This scheme enables a first-type charged particle having a smaller particle size to be packed into a space between two adjacent first-type charged particles having a larger particle size to achieve a dense arrangement of the first-type charged particles, thereby improving the ability of the first-type charged particles to reflect or absorb the ambient light, increasing the display contrast, and increasing the display effect. Additionally, the arrangement in which the charge quantity carried by a first-type charged particle having a larger particle size is greater than the charge quantity carried by a first-type charged particle having a smaller particle size can balance a moving-speed difference caused by a particle size difference, thereby ensuring that a first-type charged particle having a larger particle size has a sufficient drive force to move to the first substrate and thus ensures a dense arrangement of the first-type charged particles.

The inventors find through research that movement of a charged particle in the electrophoretic fluid is similar to movement of a spherical object in a stationary viscous fluid. According to Stokes law, the resistance ƒ overcome by the spherical object in a viscous fluid satisfies formula (1), ƒ=6πηvR. η denotes the viscosity coefficient of the liquid. v denotes the moving speed of the spherical object. R denotes the radius of the spherical object. Substituting into embodiments of the present disclosure, it can be seen that the resistance ƒ to be overcome by a charged particle is equal to

$$6 πη v \frac{D}{2} .$$

D is the particle size of the charged particle. Assuming that the charged particle moves at a constant speed in the electrophoretic fluid, the electric field force F applied to the charged particle is equal to the resistance ƒ received by the charged particle. The electric field force F is calculated using formula (2),

$$F = q \frac{U}{D} . q$$

denotes the charge quantity carried by the charged particle. U denotes the potential difference between the first substrate and the second substrate. d denotes the distance between the first substrate and the second substrate. According to formula (1) and formula (2), the moving speed v of the charged particle satisfies formula (3),

$$v = \frac{2 q}{D} \cdot \frac{U}{6 πη d} .$$

To ensure a dense arrangement of the first-type charged particles 31, some embodiments of the present disclosure propose that the moving speed of a first-type charged particle 31 having a larger particle size may be set greater than or equal to the moving speed of a first-type charged particle 31 having a smaller particle size. In this manner, the first-type charged particle 31 having a larger particle size moves faster to the first substrate 1, and then the first-type charged particle 31 having a smaller particle size moves to the first substrate 1 and enters and fills the spaces S between adjacent first-type charged particles 31 having a larger particle size.

According to formula (3), when the drive voltage is fixed, the first-type 2U charged particles 31 are the same in terms of 6πηd in formula (3), and the parameter that affects the moving speed of a first-type charged particle 31 is the ratio “of the charge quantity to the particle size. Based on this, this embodiment may control the moving speed of a first-type charged particle 31 having a different particle size by limiting the ratio of the charge quantity to the particle size of the first-type charged particle 31.

Illustratively, in some embodiments of the present disclosure, D₁>D₂, q₁>q₂, and

$$\frac{{q}_{1}}{{D}_{1}} > \frac{{q}_{2}}{{D}_{2}} .$$

When the particle size D₁ of a first charged subparticle 311 is greater than the particle size D₂ of a second charged subparticle 312 and the charge quantity q₁ carried by the first charged subparticle 311 is greater than the charge quantity q₂ carried by the second charged subparticle 312,

$$\frac{{q}_{1}}{{D}_{1}}$$

may be set greater than

$$\frac{{q}_{2}}{{D}_{2}}$$

so that in the electrophoretic fluid 30, the moving speed of the first charged subparticle 311 having a larger particle size is greater than the moving speed of the second charged subparticle 312 having a smaller particle size. When the first-type charged particles 31 are controlled to move to the first substrate 1, the first charged subparticles 311 having a larger particle size may be first arranged on the surface of the first substrate 1 facing away from the display surface, and then the second charged subparticles 312 having a smaller particle size enter and fill the spaces S between adjacent first charged subparticles 311, ensuring that the first charged subparticles 311 and the second charged subparticles 312 are densely packed, thus better ensuring the dense arrangement effect of the first-type charged particles 31.

Illustratively, in some embodiments of the present disclosure, it is feasible to set

$$\frac{{q}_{2}}{{D}_{2}} \leq \frac{{q}_{1}}{{D}_{1}} \leq 10 \frac{{q}_{2}}{{D}_{2}} .$$

In this manner, the ratio of the moving speed of the first charged subparticle 311 to the moving speed of the second charged subparticle 312 can be controlled within the range of 1:1 to 10:1, preventing the normal display from being affected by an excessive difference between the moving speed of the first charged subparticle 311 and the moving speed of the second charged subparticle 312.

Illustratively, in some embodiments of the present disclosure, it is feasible to configure that the ratio

$$\frac{{q}_{1}}{{D}_{1}}$$

of the charge quantity q₁ to the particle size D₁ of the first charged subparticle 311 is greater than the ratio

$$\frac{{q}_{2}}{{D}_{2}}$$

of the charge quantity q₂ to the particle size D₂ of the second charged subparticle 312 to satisfy the following:

$$1.5 \frac{{q}_{2}}{{D}_{2}} \leq \frac{{q}_{1}}{{D}_{1}} \leq 2.5 \frac{{q}_{2}}{{D}_{2}} .$$

That is, the ratio of the moving speed of the first charged subparticle 311 to the moving speed of the second charged subparticle 312 is within the range of 1.5 to 2.5. In this manner, both the first charged subparticles 311 and the second charged subparticles 312 can have a relatively fast moving speed, improving the overall response speed of the first-type charged particles 31 and making the electronic paper display panel have a relatively high refresh rate.

It should be noted that the particle size of a charged particle is small, so it is difficult to measure the charge quantity on the surface of the charged particle. In the art, the electrokinetic potential (Zeta potential, ( ) of a charged particle dispersed in an electrophoretic fluid is commonly used to qualitatively characterize the charge quantity carried by the charged particle. The electrokinetic potential is the electrostatic potential near the surface of the particle suspended in the liquid. The greater the absolute value of the electrokinetic potential, the greater the charge quantity carried by the charged particle, or this can be understood as that the charge quantity carried by the charged particle corresponds to the electrokinetic potential dispersed in the electrophoretic fluid.

The charge quantity carried by the charged particle in embodiments of the present disclosure may be obtained by measuring the electrokinetic potential of the charged particle dispersed in the electrophoretic fluid. For example, when the first charged subparticles are dispersed in the electrophoretic fluid, and the absolute value of a first electrokinetic potential of a first charged subparticle is |ζ₁|, the charge quantity carried on the surface of the first charged subparticle is q₁; when the second charged subparticles are dispersed in the electrophoretic fluid, and the absolute value of a second electrokinetic potential of a second charged subparticle is [ζ₂], the charge quantity carried on the surface of the second charged subparticle is q₂, and so on.

Generally, in the electronic paper display panel, the particle size of a charged particle is controlled at the nanometer level, and the electrokinetic potential of the charged particle is controlled at the millivolt level. Because the particle size of the charged particle is very small, in an actual preparation process of the charged particle, the electrokinetic potential of the charged particle can be adjusted more easily while the particle size of the charged particle can be adjusted more difficultly.

Based on this, when D₁>D₂ and q₁>q₂, an alternative embodiment of the present disclosure further proposes that (D₁-D₂)/D₂< (q₁-q₂)/q₂.

The preceding formula indicates that the change rate of the particle size of a first charged subparticle 311 and the change rate of the particle size of a second charged subparticle 312 are less than the change rate of the charge quantity carried by the first charged subparticle 311 and the change rate of the charge quantity carried by the second charged subparticle 312. The difference between the charge quantity carried by the first charged subparticle 311 and the charge quantity carried by the second charged subparticle 312 is increased appropriately so that the moving speed of the first charged subparticle 311 is increased. In this manner, the preparation difficulty of the first-type charged particles 31 at different levels can be reduced appropriately.

It should be understood that when the first-type charged particles 31 include n types of charged subparticles of different particle sizes, any two types of charged subparticles among the n types of charged subparticles of different particle sizes may also satisfy the preceding change rate relationship. Details are not described here again.

In an alternative embodiment, with continued reference to FIGS. 3 to 5, the first-type charged particles 31 also include third charged subparticles 313. The particle size of a third charged subparticle 313 is D₃. The charge quantity carried by the third charged subparticle 313 is q₃. D₁>D₂>D_{3, 91}>q₂>q₃, and

$$\frac{{q}_{1}}{{D}_{1}} > \frac{{q}_{2}}{{D}_{2}} > \frac{{q}_{3}}{{D}_{3}} .$$

As shown in FIGS. 3 to 5, the first charged subparticles 311, the second charged subparticles 312, and the third charged subparticles 313 decrease progressively in terms of particle size and decreases progressively in terms of carried charge quantity. The second charged subparticles 312 may be packed into the spaces S between adjacent first charged subparticles 311. The third charged subparticles 313 may be packed into the space S between a first charged subparticle 311 and a second charged subparticle 312 and the space S between adjacent second charged subparticles 312.

Additionally, the first charged subparticles 311, the second charged subparticles 312, and the third charged subparticles 313 decrease progressively in terms of the ratio of the carried charge quantity to the particle size so that the first charged subparticle 311 having a larger particle size has a larger response speed while the third charged subparticle 313 having a smaller particle size has a smaller response speed. In this setting manner, when the first-type charged particles 31 need to be driven to move to the first substrate 1, the three types of charged subparticles can be densely packed.

Further, as described in the preceding embodiment, the charge quantity carried by a charged particle may be reflected by the electrokinetic potential of the charged particle in the electrophoretic fluid 30. Therefore, in some embodiments, a first charged subparticle 311 in the electrophoretic fluid 30 has a first electrokinetic potential (1, a second charged subparticle 312 in the electrophoretic fluid 30 has a second electrokinetic potential 32, and a third charged subparticle 313 in the electrophoretic fluid 30 has a third electrokinetic potential ζ₃·|ζ₁|>|ζ₃|.

When the surface of a charged particle is positively charged, the electrokinetic potential of the charged particle is a positive value. When the surface of a charged particle is negatively charged, the electrokinetic potential of the charged particle is a negative value. The charge quantity and electrokinetic potential of the charged particle in the present disclosure use the absolute value of the corresponding parameter for comparison. In this embodiment, the first charged subparticles 311, the second charged subparticles 312, and the third charged subparticles 313 decrease progressively in terms of the absolute value of the electrokinetic potential so that the first charged subparticles 311, the second charged subparticles 312, and the third charged subparticles 313 decrease progressively in terms of carried charge quantity.

Illustratively, in an embodiment, values of the particle size and electrokinetic potential of each type of charged subparticles may be set as follows: 200 nm≤D₁≤400 nm, and 10 mV< [ ]<40 mV; 50 nm<D_{2≤150} nm, and 5 mV<<2|≤20 mV;

and D_{3<50} nm, and 1 mV≤|33|≤10 mV.

According to actual tests, the particle size D₁ of the first charged subparticles 311 is controlled within the range of 200 nm to 400 nm, and the absolute value |311 of the first electrokinetic potential is controlled within the range of 10 mV to 40 mV; the particle size D₂ of the second charged subparticle 312 is controlled within the range of 50 nm to 150 nm, and the absolute value 172| of the second electrokinetic potential is controlled within the range of 5 mV to 20 mV; and the particle size D₃ of the third charged subparticle 313 is controlled within the range of 0 nm to 50 nm, and the absolute value |73| of the third electrokinetic potential is controlled within the range of 1 mV to 10 mV. In this manner, all kinds of first-type charged particles 31 have a good dense arrangement effect, a good overall response speed, and a good display effect.

Alternatively, a charged particle is composed of an inorganic material and an organic material wrapped around the inorganic material. The inorganic material is the basic structure of the charged particle. The organic material is a charge control agent. In formulas (1) to (3), by default, the surface of each first-type charged particle 31 has the same organic material, and the same relative viscosity is present between the electrophoretic fluid 30 and the surface of each first-type charged particle 31 having a different size. In this case, the resistance overcome by a charged particle moving in the electrophoretic fluid 30 is calculated using formula (1). If a different relative viscosity is present between the electrophoretic fluid 30 and the surface of each first-type charged particle 31 having a different size, the moving speed of each charged particle may be analyzed from another angle. In an embodiment, when the particle size and charge quantity of a charged particle are constant, the larger the relative viscosity between the charged particle and the electrophoretic fluid, the larger the resistance overcome by the charged particle moving in the electrophoretic fluid, and the smaller the moving speed of the charged particle.

Based on this, in some embodiments of the present disclosure, the relative viscosity between the surface of the first charged subparticle 311 and the electrophoretic fluid 30 is μ₁, and the relative viscosity between the surface of the second charged subparticle 312 and the electrophoretic fluid 30 is μ₂. (D₁-D₂) X (11-12)<0.

In an embodiment, a change pattern of the particle size of a first-type charged particle 31 may be set opposite to the change pattern of the relative viscosity between the first-type charged particle 31 and the electrophoretic fluid 30. That is, the relative viscosity between the electrophoretic fluid 30 and a first-type charged particle 31 having a larger particle size is smaller, and the relative viscosity between the electrophoretic fluid 30 and a first-type charged particle 31 having a smaller particle size is larger. Thus, it is possible to reduce the relative viscosity between the first-type charged particle 31 and the electrophoretic fluid 30 to reduce the resistance applying to the first-type charged particle 31 by the electrophoretic fluid 30, further ensuring that a first-type charged particle 31 having a larger particle size has a faster moving speed.

Illustratively, when the particle size D₁ of a first charged subparticle 311 is greater than the particle size D₂ of a second charged subparticle 312, the relative viscosity μ₁ between the surface of the first charged subparticle 311 and the electrophoretic fluid 30 may be set less than the relative viscosity μ₂ between the surface of the second charged subparticle 312 and the electrophoretic fluid 30. When the first-type charged particles 31 include n types of charged subparticles of different particle sizes, any two types of charged subparticles among the n types of charged subparticles of different particle sizes may also satisfy the preceding relationship between the particle size and the relative viscosity.

Further, in some alternative embodiments, the particle sizes of the first-type charged particles 31 may be set to ensure that the first-type charged particles 31 are densely packed. According to the principle of the closest packing, spheres of different sizes are generally packed as follows: Larger spheres are packed according to hexagonal close packing and cubic close packing, and then smaller spheres are packed into the octahedral space and the tetrahedral space between the packed larger spheres.

Based on this, in some embodiments of the present disclosure, the particle size D₁ of a first charged subparticle 311 and the particle size D₂ of a second charged subparticle 312 satisfy the following relationship:

$$\frac{{D}_{2}}{{D}_{1}} \leq 0.414 .$$

According to geometry, assuming that the length of each side of a regular octahedron is L, then the diagonal of the regular octahedron is \sqrt{2L}. In this case, assuming that the diameter of a larger sphere and the diameter of a smaller sphere are R1 and R2 respectively, the smaller spheres need to be packed into the octahedral spaces after the larger spheres are densely packed, then L=2R1 and \sqrt{2L}=2R1+2R2. From this,

$$\frac{R 1}{R 2} = \sqrt{2} - 1 = 0.414 .$$

In conjunction with this embodiment, to ensure that the second charged subparticles 312 having a smaller particle size are packed into the octahedral spaces between the first charged subparticles 311, the following may be set:

$$\frac{{D}_{2}}{{D}_{1}} \leq 0.414 .$$

Alternatively, in other possible embodiments, the following may be set:

$$\frac{{D}_{2}}{{D}_{1}} \leq 0.225 .$$

According to geometry, assuming that the length of each side of a regular tetrahedron is L, then the distance from the center of the regular tetrahedron to each vertex of the regular tetrahedron is

$$\frac{L \sqrt{6}}{4} .$$

In this case, assuming that the diameter of a larger sphere and the diameter of a smaller sphere are R1 and R2 respectively, the smaller spheres need to be packed into the tetrahedral spaces after the larger spheres are densely packed, then L=2R1 and

$$\frac{L \sqrt{6}}{4} L = R 1 + R 2 .$$

From this,

$$\frac{R 1}{R 2} = \frac{\sqrt{6}}{2} - 1 = 0225 .$$

In conjunction with this embodiment, to ensure that the second charged subparticles 312 having a smaller particle size are packed into the tetrahedral spaces between the first charged subparticles 311, the following may be set:

$$\frac{{D}_{2}}{{D}_{1}} \leq 0.225 .$$

When the particle size D₁ of a first charged subparticle 311 and the particle size D₂ of a second charged subparticle 312 satisfy the above relationship, the second charged subparticle 312 can fill either a tetrahedral space or an octahedral space.

Further, in a possible embodiment, when D₁>D₂, the ratio of the number of first charged subparticles 311 to the number of second charged subparticles 312 is within the range of 1:2 to 1:1.

In an embodiment, according to the spherical dense packing, in a system composed of x spheres having the same diameter, there are 2x tetrahedral spaces and x octahedral spaces. Therefore, in this embodiment, the number of second charged subparticles 312 may be set to be once or twice the number of first charged subparticles 311 so that as many second charged subparticles 312 as possible can be packed into the space between first charged subparticles 311.

Certainly, the radius and number of the first charged subparticles 311 and the second charged subparticles 312 are optional, may be set according to the actual situations in practical use, and are not limited by this embodiment.

FIG. 6 is a diagram illustrating variations in the electric intensity of a first electric field according to an embodiment of the present disclosure. Referring to FIGS. 3 and 6, in a possible embodiment, the electronic paper display panel has a first display state. In the first display state, a first electric field 1 is formed between the first substrate 1 and the second substrate 2. In the first electric field q₁, the first-type charged particles move to the first substrate 1. The electric intensity E of the first electric field q₁ gradually increases as the driving time length t increases within the time length of one frame in the first display state.

In an embodiment, the first display state may be a pure color display state. FIG. 3 shows the first display state. When the first-type charged particles 31 are white charged particles, the first display state is a white display state. In the first display state, a first electric field o1 is formed between the first substrate 1 and the second substrate 2. Under the action of the first electric field q₁, the first-type charged particles 31 move to the side of the first substrate 1 facing away from the display surface so that the first-type charged particles 31 are densely arranged on the side of the first substrate 1.

It is worth mentioning that the first-type charged particles 31 of different particle sizes have different moving speeds and thus may have different response speeds when responding to the electric field. For example, under the same electric intensity, a first-type charged particle 31 having a larger moving speed may more easily respond to the first electric field q₁ and move to the first substrate 1 while a first-type charged particle 31 having a smaller moving speed has a slower response speed.

According to the analysis in the preceding embodiments, the moving speed of a charged particle may be reflected by the ratio of the charge quantity of the charged particle to the particle size of the charged particle. When the ratio

$$\frac{{q}_{1}}{{D}_{1}}$$

of the charge quantity q₁ to the particle size D₁ of the first charged subparticle 311 being greater than the ratio

$$\frac{{q}_{2}}{{D}_{2}}$$

of the charge quantity q₂ to the particle size D₂ of the second charged subparticle 312 is still taken as an example, the first charged subparticle 311 is more prone to move under the first electric field q₁ than the second charged subparticle 312. Therefore, this embodiment proposes that within the time length of one frame in the first display state, the electric intensity E of the first electric field q₁ may be gradually increased. That is, within the time length of one frame, the electric intensity E of the first electric field q₁ is positively correlated with the driving time length t. At the early stage of driving, the first-type charged particles 31 are driven under the first electric field q₁ having a smaller electric intensity. At the late stage of driving, the first-type charged particles 31 are driven under the first electric field q₁ having a larger electric intensity. In this manner, at the early stage of driving, the first charged subparticles 311 having a larger particle size are more prone to respond to the first electric field q₁ and move to the first substrate 1 so that the first charged subparticles 311 are first arranged on the side of the first substrate 1; and then the electric intensity E of the first electric field q₁ is increased to make a larger driving force applied to the second charged subparticles 312, ensuring that the second charged subparticles 312 can enter the space S between two adjacent first charged subparticles 311, thus better ensuring the dense arrangement effect of the first-type charged particles 31.

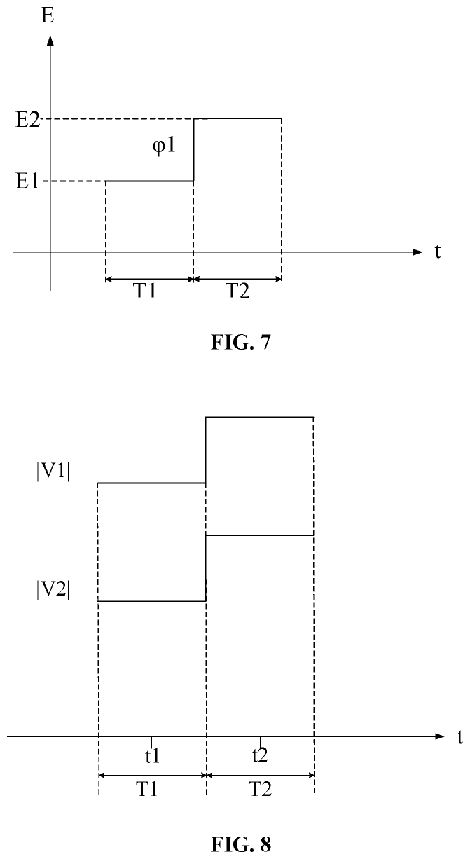

Alternatively, in another possible embodiment, the electronic paper display panel may still have a first display state. In the first display state, a first electric field is formed between the first substrate 1 and the second substrate 2. Under the first electric field, the first-type charged particles 31 move to the first substrate 1. FIG. 7 is a diagram illustrating variations in the electric intensity of another electric field according to an embodiment of the present disclosure. Referring to FIG. 7, the time length of one frame in the first display state contains a first driving sub-stage T1 and a second driving sub-stage T2 that are arranged sequentially in the time dimension. The first electric field q₁ has a first electric intensity E1 at the first driving sub-stage T1. The first electric field q₁ has a second electric intensity E2 at the second driving sub-stage T2. The second electric intensity E2 is greater than the second electric intensity E2.

In this embodiment, the first display state is the same as that in the previous embodiment and is not described again here. As shown in FIG. 7, this embodiment is different from the previous embodiment in that the electric intensity of the first electric field q₁ does not need to keep increasing within the time length of one frame in the first display state in this embodiment. The time length of one frame is divided into the first driving sub-stage T1 and the second driving sub-stage T2. The first driving sub-stage T1 is at the early stage of driving. The second driving sub-stage T2 is at the late stage of driving. The electric intensity of the first electric field q₁ remains unchanged at the first electric intensity E1 in the first driving sub-stage T1. When the second driving sub-stage T2 is entered, the electric intensity of the first electric field q₁ is increased to the second electric intensity E2 and remains at the second electric intensity E2. In this manner, the effect of the previous embodiment shown in FIG. 6 can also be achieved, and in this embodiment, there is no need to continuously adjust the electric intensity of the first electric field q₁, and the driving method is relatively simple.

In other embodiments not shown, the first electric field within the time length of one frame can be adjusted in manners other than the previous manner as long as the following is set: Within the time length of one frame in the first display state, there are at least two times at which the first electric field has different electric intensities, and in the time dimension, the electric intensity of the first electric field at an earlier time of the at least two times is smaller than the electric intensity of the first electric field at a later time of the at least two times.

Certainly, within the time length of one frame in the first display state, the electric intensity of the first electric field applied to the plasma layer may also remain unchanged and may be set by those skilled in the art according to actual requirements. Further, with continued reference to FIG. 3, in an embodiment, the first-type charged particles 31 are positively charged; the first substrate 1 includes a common electrode layer 11, the second substrate 2 includes multiple pixel electrodes 21, and in the first display state, a first voltage is applied to the common electrode layer 11 and a second voltage is applied to the multiple pixel electrodes 21 so that the first electric field is formed. The first voltage has a negative value, and the second voltage has a positive value. The time length of one frame in the first display state includes a first time and a second time, in the time dimension, the first time is earlier than the second time, and the electric intensity of the first electric field at the second time is greater than the electric intensity of the first electric field at the first time; and the absolute value of the first voltage applied to the common electrode layer 11 at the first time is less than the absolute value of the first voltage applied to the common electrode layer 11 at the second time.

As shown in FIG. 3, the common electrode layer 11 may be a monolithic common layer, and each pixel electrode 21 is disposed separately so that image display in each region is achieved. When the first-type charged particles 31 are positively charged, the first voltage (negative voltage) is transmitted to the common electrode layer 11 and the second voltage (positive voltage) is transmitted to the pixel electrodes 21 so that the first electric field is formed. The direction of the first electric field points from the second substrate 2 to the first substrate 1. At the action of the first electric field, the positively charged first-type charged particles 31 move to the first substrate 1.

The magnitude of the first voltage applied to the common electrode layer 11 is adjusted so that the electric intensity of the first electric field is adjusted. For example, FIG. 8 is a drive timing diagram of an electronic paper display panel according to an embodiment of the present disclosure. The voltage change pattern in the embodiment shown in FIG. 8 matches the electric intensity shown in FIG. 7. Referring to FIGS. 7 and 8, the first time t1 may refer to any time at the first driving sub-stage T1, and the second time t2 may refer to any time at the second driving sub-stage T2. In this embodiment, the magnitude of the absolute value |V1| of the first voltage transmitted to the common electrode layer 11 may be increased so that the electric intensity of the first electric field q₁ is increased. For example, if the first voltage transmitted to the common electrode layer 11 at the first time t1 is −5 V, the first voltage transmitted to the common electrode layer 11 at the second time t2 may be −10 V.

Alternatively, with continued reference to FIGS. 7 and 8, in a possible embodiment, in at least part of the time length of one frame in the first display state, the absolute value |V1| of the first voltage is equal to the absolute value |V2| of the second voltage.

As shown in FIGS. 7 and 8, in this embodiment of the present disclosure, the value of the first voltage and the value of the second voltage may be adjusted simultaneously so that the electric intensity of the first electric field is adjusted. That is, the absolute value |V1| of the first voltage and the absolute value |V2| of the second voltage are increased simultaneously at the second time t2 so that the absolute value |V1| of the first voltage is equal to the absolute value |V2| of the second voltage at the second time t2. For example, if the first voltage transmitted to the common electrode layer 11 at the first time t1 is −5 V and the second voltage transmitted to the pixel electrodes 21 at the first time t1 is +5 V, the first voltage transmitted to the common electrode layer 11 at the second time t2 may be −10 V and the second voltage transmitted to the pixel electrodes 21 at the second time t2 may be+10 V.

An advantage of this configuration is that as the value of the positive voltage received by the pixel electrodes 21 increases, the pixel electrodes 21 reject the first-type charged particles 31 by using larger force so that the second charged subparticles 312 enter the spaces S between adjacent first charged subparticles 311 more easily.

In other embodiments not shown, the electric intensity of the first electric field can be increased simply in the following manner: The absolute value |V1| of the first voltage is increased while the second voltage received by the pixel electrodes 21 is not adjusted. This simplifies the driving process.

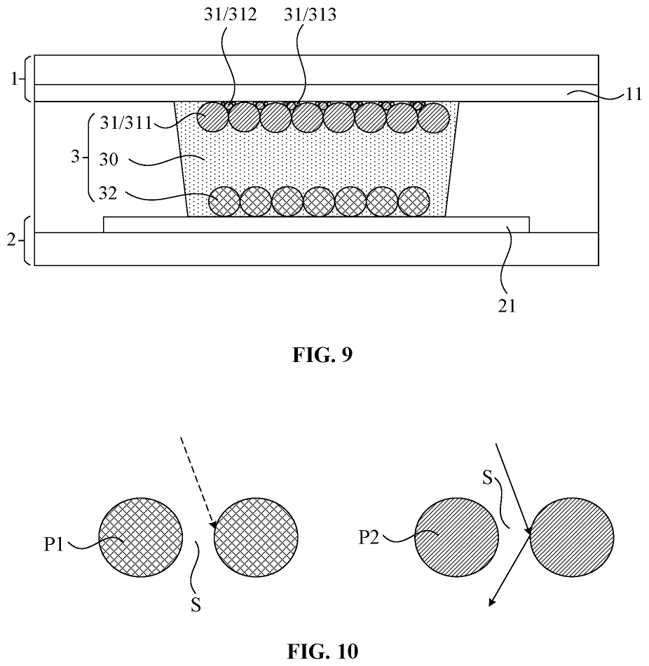

FIG. 9 is a diagram illustrating the structure of another electronic paper display panel according to an embodiment of the present disclosure. Alternatively, as shown in FIG. 9, the plasma layer 3 also includes second-type charged particles 32. The second-type charged particles 32 have charges with a second electrical property that is opposite to the first electrical property. The second-type charged particles 32 are the same in terms of particle size and the same in terms of carried charge quantity.

In an embodiment, the second-type charged particles 32 are electrically opposite to the first-type charged particles 31. If the first-type charged particles 31 are positively charged, the second-type charged particles 32 are negatively charged.

Alternatively, in a possible embodiment, the first-type charged particles 31 are white charged particles while the second-type charged particles 32 are black charged particles.

A white charged particle reflects the ambient light to make an image white while a black charged particle absorbs the ambient light to make an image black. FIG. 10 is a diagram illustrating light reflection of charged particles according to an embodiment of the present disclosure. In FIG. 10, a black dotted arrow indicates light reflection on the surface of black charged particle P1 while a black solid arrow indicates light reflection on the surface of white charged particle P2. As shown by the black dotted arrow, part of light emitted into the space S between black charged particles P1 is emitted to the surface of a black charged particle P1 and then absorbed by this black charged particle P1. Part of light emitted into the space S between white charged particles P2 is emitted to the surface of a white charged particle P2 and then reflected by this white charged particle P2. This part of light cannot be emitted upwards if no white charged particles P2 are packed in the light reflection direction. It can be seen from this that the dense arrangement effect of the white charged particles P2 has a great effect on the white-state display. Therefore, in this embodiment, the second-type charged particles may be set as black charged particles and are not set differentially. The second-type charged particles 32 are the same in terms of particle size and the same in terms of carried charge quantity, simplifying the difficulty in preparing charged particles.

Further, with continued reference to FIG. 9, in a possible embodiment, the particle size of a second-type charged particle 32 may be set to be greater than the particle size of at least part of the first-type charged particles 31.

In an embodiment, when the display panel displays black, the second-type charged particles 32 are located on the side of the first substrate 1 while the first-type charged particles 31 are located on the side of the second substrate 2; and when the display panel displays white, the first-type charged particles 31 are located on the side of the first substrate 1 while the second-type charged particles 32 are located on the side of the second substrate 2. When a black image is switched to a white image, the second-type charged particles 32 move to the second substrate 2, and the first-type charged particles 31 move to the first substrate 1. When a white image is switched to a black image, the second-type charged particles 32 move to the first substrate 1, and the first-type charged particles 31 move to the second substrate 2. In this embodiment, the particle size of a second-type charged particle 32 (that is, a black charged particle) may be set greater than or equal to the particle size of a first-type charged particle 31 (that is, a white charged particle) of an intermediate size. That is, the second-type charged particles 32 have a larger particle size than part of the first-type charged particles 31. For example, as shown in FIG. 9, the particle size of a second-type charged particle 32 is greater than the particle size of a second charged subparticle 312 and the particle size of a third charged subparticle 313. It is to be understood that a larger space S is formed between charged particles having a larger particle size. Thus a larger space S is formed between second-type charged particles 32. When an image is switched, first-type charged particles 31 having a smaller particle size can more easily pass through the spaces S between second-type charged particles 32, thereby improving the response speed of the charged particles.

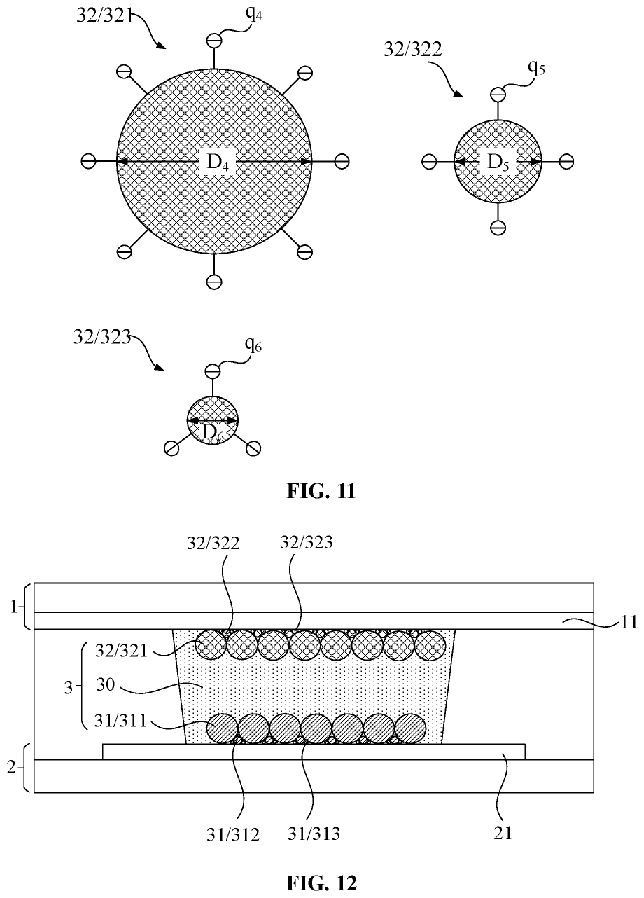

In other possible embodiments, the plasma layer 3 may also include second-type charged particles 32. The second-type charged particles 32 have charges with a second electrical property that is opposite to the first electrical property. FIG. 11 is a diagram illustrating the structures of second-type charged particles according to an embodiment of the present disclosure. Referring to FIGS. 3, 4, and 11, the second-type charged particles 32 may include fourth charged subparticles 321 and fifth charged subparticles 322. The particle size of a fourth charged subparticle 321 is D₄. The particle size of a fifth charged subparticle 322 is D₅. The charge quantity carried by the fourth charged subparticle 321 is q₄. The charge quantity carried by the fifth charged subparticle 322 is q₅. (D₄-D₅) X (q₄-95)>0.

The second-type charged particles 32 may still be black charged particles that are negatively charged. Different from the previous embodiment, in this embodiment, the second-type charged particles 32 may also be set differentially at multiple levels. As shown in FIGS. 3, 4, and 11, the second-type charged particles 32 may include charged subparticles having at least two particle sizes. The charged subparticles at different levels are the same in terms of the change pattern of the particle size and the carried charge quantity. A second-type charged particle 32 having a larger particle size carries a larger charge quantity. A second-type charged particle 32 having a smaller particle size carries a smaller charge quantity.

Illustratively, the second-type charged particles 32 include at least fourth charged subparticles 321 and fifth charged subparticles 322. The particle size of a fourth charged subparticle 321 is D₄. The particle size of a fifth charged subparticle is D₅. The charge quantity carried by the fourth charged subparticle 321 is q₄. The charge quantity carried by the fifth charged subparticle 322 is q₅. (D₄-D₅) X (q₄-95)>0.

This setting enables a better dense arrangement effect of the second-type charged particles 32. With this setting, partial ambient light may be absorbed by a second-type charged particle 32 having a smaller particle size in the space S between two adjacent second-type charged particles 32 having a larger particle size after partial ambient light illuminates the two adjacent second-type charged particles 32 having a larger particle size, thereby improving the efficiency in absorbing light in the plasma layer 3, making the black state blacker.

Among the second-type charged particles 32, a fourth charged subparticle 321 and a fifth charged subparticle 322 are two types of charged subparticles having different particle sizes. The “fourth” and “fifth” charged subparticles among the second-type charged particles 32 and the “first”, “second”, and “third” charged subparticles among the first-type charged particles 31 are names of different types of charged subparticles.

These names do not indicate the order of the charged subparticles.

Further, alternatively, in some embodiments of the present disclosure, the following may be set: D₄>D_{5, 94}>q₅, and

$$\frac{{q}_{4}}{{D}_{4}} > \frac{{q}_{5}}{{D}_{5}} .$$

Similar to the change pattern of the first-type charged particles 31 in the previous embodiment, in this embodiment,

$$\frac{{q}_{4}}{{D}_{4}}$$

may be set greater than

$$\frac{{q}_{5}}{{D}_{5}}$$

so that in the electrophoretic fluid 30, the moving speed of the fourth charged subparticle 321 having a larger particle size is greater than the moving speed of the fifth charged subparticle 322 having a smaller particle size. When the second-type charged particles 32 are controlled to move to the first substrate 1, the fourth charged subparticles 321 having a larger particle size can be first arranged on the surface of the first substrate 1 facing away from the display surface, and then the fifth charged subparticles 322 having a smaller particle size enter and fill the space S between adjacent fourth charged subparticles 321, ensuring that the fourth charged subparticles 321 and the fifth charged subparticles 322 are densely packed, thus better ensuring the dense arrangement effect of the second-type charged particles 32.

In other embodiments, the relationship between the fourth charged subparticles 321 and the fifth charged subparticles 322 may be the same as the relationship between the first charged subparticles 311 and the second charged subparticles 312 in the previous embodiments and thus is not described here. Additionally, as shown in FIGS. 3, 4, and 11, the second-type charged particles 32 may also include sixth charged subparticles 323. The relationship between the fourth charged subparticles 321, the fifth charged subparticles 322, and the sixth charged subparticles 323 is the same as the relationship between the first charged subparticles 311, the second charged subparticles 312, and the third charged subparticles 313 in the previous embodiments and thus is not described here.

Additionally, in an alternative embodiment, the multi-level charged subparticles among the first-type charged particles 31 and the multi-level charged subparticles among the second-type charged particles 32 are in one-to-one correspondence in terms of particle size and charge quantity. It is assumed that the first-type charged particles 31 include first charged subparticles 311, second charged subparticles 312, and third charged subparticles 313 and that the second-type charged particles 32 include fourth charged subparticles 321, fifth charged subparticles 322, and sixth charged subparticles 323. A first charged subparticle 311 and a fourth charged subparticle 321 may have the same particle size (the particle size of the first charged subparticle 311 is denoted by D₁, and the particle size of the fourth charged subparticle 321 is denoted by D₄), the same charge quantity, and different electrical properties. A second charged subparticle 312 and a fifth charged subparticle 322 may have the same particle size (the particle size of the second charged subparticle 312 is denoted by D₂, and the particle size of the fifth charged subparticle 322 is denoted by D₅), the same charge quantity, and different electrical properties. A third charged subparticle 313 and a sixth charged subparticle 323 may have the same particle size (the particle size of the third charged subparticle 313 is denoted by D₃, and the particle size of the sixth charged subparticle 323 is denoted by D₆), the same charge quantity, and different electrical properties. In this manner, the first-type charged particles 31 and the second-type charged particles 32 are uniformly arranged in the electrophoretic fluid 30, and the two types of charged particles are the same in terms of the absolute value of the driving voltage and are substantially the same in terms of response speed, thereby improving the display uniformity.

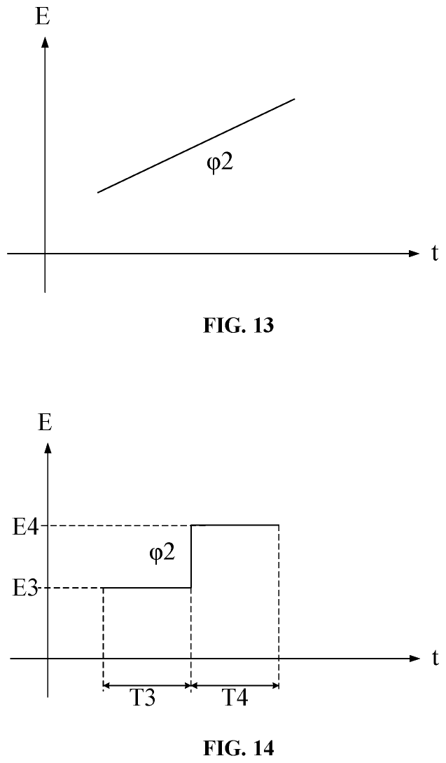

FIG. 12 is a diagram illustrating the structure of another electronic paper display panel according to an embodiment of the present disclosure. FIG. 13 is a diagram illustrating variations in the electric intensity of a second electric field according to an embodiment of the present disclosure. FIG. 14 is a diagram illustrating variations in the electric intensity of another second electric field according to an embodiment of the present disclosure. Referring to FIG. 4 and FIGS. 11 to 14, in a possible embodiment, the electronic paper display panel may also include a second display state (shown in FIG. 12). The second display state may be a black display state. In the second display state, a second electric field q₂ is formed between the first substrate 1 and the second substrate 2. Under the action of the second electric field q₂, the second-type charged particles 32 move to the side of the first substrate 1 facing away from the display surface so that the second-type charged particles 32 are densely arranged on the side of the first substrate 1. The electric intensity E of the second electric field q₂ gradually increases as the driving time length increases within the time length of one frame in the second display state. Alternatively, the time length of one frame in the second display state contains a third driving sub-stage T3 and a fourth driving sub-stage T4 that are arranged in sequence in the time dimension. The second electric field o2 has a third electric intensity E3 at the third driving sub-stage T3. The second electric field o2 has a fourth electric intensity E4 at the fourth driving sub-stage T4. The third electric intensity E3 is less than the fourth electric intensity E4. In this manner, at the early stage of driving, the fourth charged subparticles 321 having a larger particle size are more prone to respond to the second electric field 2 and move to the first substrate 1 so that the fourth charged subparticles 321 are first arranged on the side of the first substrate 1; and then the electric intensity of the second electric field q₂ is increased to make a larger driving force applied to the fifth charged subparticles 322, ensuring that the fifth charged subparticles 322 can enter the space S between two adjacent fourth charged subparticles 321, thus better ensuring the dense arrangement effect of the second-type charged particles 32. FIG. 4 shows that in the second display state, the second-type charged particles 32 move to the first substrate 1 and the first-type charged particles 31 move to the second substrate 2.

For details about the driving process of the second-type charged particles 32 in the second display state, reference is made to the previous embodiments. Illustratively, a third voltage is applied to the common electrode layer 11 and a fourth voltage is applied to the pixel electrodes 21 in the second display state so that a second electric field is formed. The third voltage is a positive value. The fourth voltage is a negative value. The time length of one frame in the second display state includes a third time and a fourth time. In the time dimension, the third time is earlier than the fourth time. The electric intensity of the second electric field at the third time is greater than the electric intensity of the second electric field at the fourth time. The absolute value of the third voltage applied to the common electrode layer 11 at the third time is less than the absolute value of the third voltage applied to the common electrode layer 11 at the fourth time. The magnitude of the third voltage applied to the common electrode layer 11 is adjusted so that the electric intensity of the second electric field is adjusted.

Illustratively, in at least part of one frame in the second display state, the absolute value of the third voltage is equal to the absolute value of the fourth voltage, and values of the third voltage and the fourth voltage are adjusted so that the electric intensity of the second electric field is adjusted.

For details about the drive mode in the second display state, reference is made to the drive mode in the first display state in the previous embodiments. Details about the drive mode in the second display state are not described here.

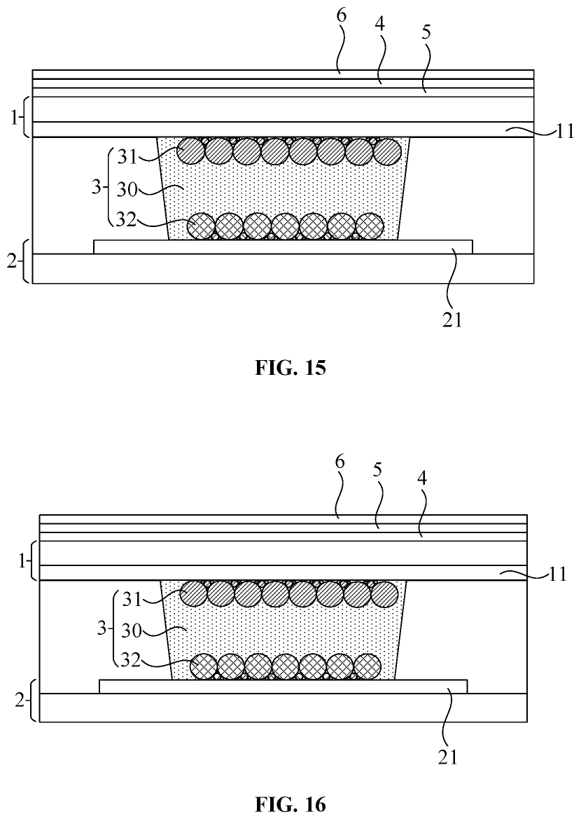

FIG. 15 is a diagram illustrating the structure of another electronic paper display panel according to an embodiment of the present disclosure. FIG. 16 is a diagram illustrating the structure of another electronic paper display panel according to an embodiment of the present disclosure. Referring to FIG. 15 or FIG. 16, in a possible embodiment, the electronic paper display panel may also include an anti-reflection layer 4 and an anti-glare layer 5. The anti-reflection layer 4 is disposed on the side of the first substrate 1 facing away from the second substrate 2. The anti-glare layer 5 is located between the first substrate 1 and the anti-reflection layer 4. Alternatively, the anti-glare layer 5 is located on the side of the anti-reflection layer 4 facing away from the first substrate 1.

The anti-reflection layer 4 and the anti-glare layer 5 may be laid on the display surface side of the first substrate 1. The anti-reflection layer 4 is configured to reduce the reflectance of the display surface of the first substrate 1 to achieve anti-reflection. The anti-reflection layer 4 may be formed of high-refractive-index and low-refractive-index materials stacked in sequence. For example, the anti-reflection layer 4 may be formed of TiO₂ and SiO₂ layers stacked in sequence. This is not limited by this embodiment. The anti-reflection layer 4 can reduce the surface reflectivity of the display surface of the electronic paper display panel, improve the display contrast, and thus improve the display effect. The anti-glare layer 5 can improve the viewing angle of images, reduce interference by the ambient light, and reduce screen glare. The anti-glare layer 5 may be formed of SiO₂. This is not limited by this embodiment.

This embodiment of the present disclosure does not limit the relative position relationship between the anti-reflection layer 4 and the anti-glare layer 5. In the embodiment shown in FIG. 15, the first substrate 1, the anti-glare layer 5, and the anti-reflection layer 4 are stacked in sequence. In the embodiment shown in FIG. 16, the first substrate 1, the anti-reflection layer 4, and the anti-glare layer 5 are stacked in sequence. Those skilled in the art may set the relative positions of the anti-reflection layer 4 and the anti-glare layer 5 according to the actual requirements.

Alternatively, with continued reference to FIGS. 15 and 16, in a possible embodiment, the electronic paper display panel may also include an anti-fingerprint layer 6. The anti-fingerprint layer 6 is located on the side of the anti-reflection layer 4 or the anti-glare layer 5 facing away from the first substrate 1.

In an embodiment, the anti-fingerprint layer 6 may be disposed on the outermost side of the display surface of the electronic paper display panel. For example, in FIG. 15, the anti-fingerprint layer 6 is located on the side of the anti-reflection layer 4 facing away from the anti-glare layer 5. Alternatively, in FIG. 16, the anti-fingerprint layer 6 is located on the side of the anti-glare layer 5 facing away from the anti-reflection layer 4. The anti-fingerprint layer 6 can reduce the surface tension of the first substrate 1 so that the electronic paper display panel is more hydrophobic, oilproof, and fingerprintproof.

The materials and preparation techniques of the anti-reflection layer 4, the anti-glare layer 5, and the anti-fingerprint layer 6 are configured by those skilled in the art according to actual requirements. This is not described and limited by embodiments of the present disclosure.

The electronic paper display panel provided by embodiments of the present disclosure may also include any structure that can be learned by those skilled in the art, for example, a pixel driving circuit layer. This is not described and limited by embodiments of the present disclosure.

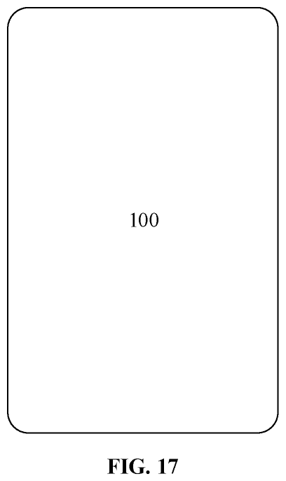

Based on the same inventive concept, an embodiment of the present disclosure provides a display device. FIG. 17 is a diagram illustrating the structure of a display device according to an embodiment of the present disclosure. As shown in FIG. 17, the display device includes the electronic paper display panel 100 of any embodiment of the present disclosure. Therefore, the display device of this embodiment of the present disclosure has the beneficial effects of the display panel of any embodiment of the present disclosure. The beneficial effects are not repeated here. Illustratively, the display device may be an electronic device such as a mobile phone, a computer, a smart wearable device (for example, a smart watch), or an in-vehicle display device. This is not limited by this embodiment of the present disclosure.

It is to be noted that the preceding are only alternative embodiments of the present disclosure and the technical principles used therein. It is to be understood by those skilled in the art that the present disclosure is not limited to the embodiments described herein. Those skilled in the art can make various apparent modifications, adaptations, combinations and substitutions without departing from the scope of the present disclosure. Therefore, although the present disclosure has been described in detail through the preceding embodiments, the present disclosure is not limited to the preceding embodiments and may include other equivalent embodiments without departing from the concept of the present disclosure. The scope of the present disclosure is determined by the scope of the appended claims.

What is claimed is:

1. An electronic paper display panel, comprising a first substrate and a second substrate opposite to each other and a plasma layer between the first substrate and the second substrate, wherein
the plasma layer comprises an electrophoretic fluid and first-type charged particles, wherein
the first-type charged particles have charges with a first electrical property, and the first-type charged particles comprise first charged subparticles and second charged subparticles, wherein a first charged subparticle of the first charged subparticles has a particle size of D₁, a second charged subparticle of the second charged subparticles has a particle size of D₂, a charge quantity carried by the first charged subparticle is q₁, and a charge quantity carried by the second charged subparticle is q₂, wherein
$$( {D}_{1} - {D}_{2} ) \times ( {q}_{1} - {q}_{2} ) > 0 .$$

2. The electronic paper display panel of claim 1, wherein
$${D}_{1} > {D}_{2} , {q}_{1} > {q}_{2} , and \frac{{q}_{1}}{{D}_{1}} > \frac{{q}_{2}}{{D}_{2}} .$$

3. The electronic paper display panel of claim 2, wherein
$$1.5 \frac{{q}_{2}}{{D}_{2}} \leq \frac{{q}_{1}}{{D}_{1}} \leq 2.5 \frac{{q}_{2}}{{D}_{2}} .$$

4. The electronic paper display panel of claim 1, wherein
$${D}_{1} > {D}_{2} , {q}_{1} > {q}_{2} , and ( {D}_{1} - {D}_{2} ) / {D}_{2} < ( {q}_{1} - {q}_{2} ) / {q}_{2} .$$

5. The electronic paper display panel of claim 1, wherein a relative viscosity between a surface of the first charged subparticle and the electrophoretic fluid is μ₁, and a relative viscosity between a surface of the second charged subparticle and the electrophoretic fluid is μ₂, wherein
$$( {D}_{1} - {D}_{2} ) \times ( {μ}_{1} - {μ}_{2} ) < 0.$$

6. The electronic paper display panel of claim 1, wherein
$$\frac{{D}_{2}}{{D}_{1}} \leq 0.414 .$$

7. The electronic paper display panel of claim 1, wherein D₁>D₂; and
a ratio of a number of the first charged subparticles to a number of the second charged subparticles is between 1:2 and 1:1.

8. The electronic paper display panel of claim 1, wherein the first-type charged particles further comprise third charged subparticles, wherein a third charged subparticle of the third charged subparticles has a particle size of D₃, and a charge quantity carried by the third charged subparticle is q₃, wherein
$${D}_{1} > {D}_{2} {D}_{3} , {q}_{1} > {q}_{2} > {q}_{3} , and \frac{{q}_{1}}{{D}_{1}} > \frac{{q}_{2}}{{D}_{2}} > \frac{{q}_{3}}{{D}_{3}} .$$

9. The electronic paper display panel of claim 8, wherein the first charged subparticle has a first electric potential of ƒ₁ in the electrophoretic fluid, the second charged subparticle has a second electric potential of ƒ₂ in the electrophoretic fluid, and the third charged subparticle has a third electric potential of ƒ₃ in the electrophoretic fluid, wherein
$$\vert {ζ}_{1} \vert > \vert {ζ}_{2} \vert > \vert {ζ}_{3} \vert .$$

10. The electronic paper display panel of claim 9, wherein
200 nm≤D₁≤400 nm, and 10 mV≤|ƒ₁|≤40 mV;
50 nm≤D₂≤150 nm, and 5 mV≤|ƒ₂|≤20 mV; and
D₃<50 nm, and 1 mV≤|ƒ₃|≤10 mV.

11. The electronic paper display panel of claim 1, wherein the electronic paper display panel has a first display state, wherein in the first display state, a first electric field is formed between the first substrate and the second substrate, wherein in the first electric field, the first-type charged particles move to the first substrate; and
an electric intensity of the first electric field gradually increases as a driving time length increases within a time length of one frame in the first display state.

12. The electronic paper display panel of claim 1, wherein the electronic paper display panel has a first display state, wherein in the first display state, a first electric field is formed between the first substrate and the second substrate, wherein in the first electric field, the first-type charged particles move to the first substrate; and
a time length of one frame in the first display state comprises a first driving sub-stage and a second driving sub-stage sequentially arranged in a time dimension, and the first electric field has a first electric intensity in the first driving sub-stage and a second electric intensity in the second driving sub-stage, wherein the second electric intensity is greater than the first electric intensity.

13. The electronic paper display panel of claim 12, wherein the first-type charged particles are positively charged;
the first substrate comprises a common electrode layer, the second substrate comprises a plurality of pixel electrodes, and in the first display state, a first voltage is applied to the common electrode layer and a second voltage is applied to the plurality of pixel electrodes so that the first electric field is formed, wherein the first voltage has a negative value, and the second voltage has a positive value;
the time length of the one frame in the first display state comprises a first time and a second time, wherein in the time dimension, the first time is earlier than the second time, and the electric intensity of the first electric field at the second time is greater than the electric intensity of the first electric field at the first time; and
an absolute value of the first voltage applied to the common electrode layer at the first time is less than an absolute value of the first voltage applied to the common electrode layer at the second time.

14. The electronic paper display panel of claim 13, wherein in at least part of time within the time length of the one frame in the first display state, an absolute value of the first voltage is equal to an absolute value of the second voltage.

15. The electronic paper display panel of claim 1, wherein the plasma layer further comprises second-type charged particles, wherein the second-type charged particles have charges with a second electrical property that is opposite to the first electrical property; and
the second-type charged particles are the same in terms of particle size and the same in terms of carried charge quantity;
wherein the second-type charged particles are greater than at least part of the first-type charged particles in terms of particle size.

16. The electronic paper display panel of claim 1, wherein the plasma layer further comprises second-type charged particles, wherein the second-type charged particles have charges with a second electrical property that is opposite to the first electrical property; and
the second-type charged particles comprise fourth charged subparticles and fifth charged subparticles, wherein a fourth charged subparticle of the fourth charged subparticles has a particle size of D₄, a fifth charged subparticle of the fifth charged subparticles has a particle size of D₅, a charge quantity carried by the fourth charged subparticle is q₄, and a charge quantity carried by the fifth charged subparticle is q₅, wherein
$$( {D}_{4} - {D}_{5} ) \times ( {q}_{4} - {q}_{5} ) > 0.$$

17. The electronic paper display panel of claim 16, wherein
$${D}_{4} > {D}_{4} , {q}_{4} > {q}_{5} and \frac{{q}_{4}}{{D}_{4}} > \frac{{q}_{5}}{{D}_{5}} .$$

18. The electronic paper display panel of claim 16, wherein the first-type charged particles are white charged particles, and the second-type charged particles are black charged particles.

19. The electronic paper display panel of claim 1, further comprising an anti-reflection layer and an anti-glare layer, wherein the anti-reflection layer is disposed on a side of the first substrate facing away from the second substrate, and the anti-glare layer is located between the first substrate and the anti-reflection layer or on a side of the anti-reflection layer facing away from the first substrate.

20. A display device, comprising an electronic paper display panel, wherein the electronic paper display panel comprises a first substrate and a second substrate opposite to each other and a plasma layer between the first substrate and the second substrate, wherein the plasma layer comprises an electrophoretic fluid and first-type charged particles, wherein the first-type charged particles have charges with a first electrical property, and the first-type charged particles comprise first charged subparticles and second charged subparticles, wherein a first charged subparticle of the first charged subparticles has a particle size of D₁, a second charged subparticle of the second charged subparticles has a particle size of D₂, a charge quantity carried by the first charged subparticle is q₁, and a charge quantity carried by the second charged subparticle is q₂, wherein (D₁-D₂)× (q₁-q₂)>0.
